(19) United States
(12) Patent Application Publication
(10) Pub. No.: US 2026/0019507 A1
(43) Pub. Date: Jan. 15, 2026

(54) GENERATING AUDIO STREAMS FROM MODIFIED AUDIO STREAMS AND INFORMATION ABOUT THE MODIFICATIONS TO THE AUDIO STREAMS

(71) Applicant: Zoom Video Communications, Inc., San Jose, CA (US)

(72) Inventors: Zhaofeng Jia, Saratoga, CA (US); Zhenquan Li, Hangzhou (CN); Yifei Qi, Hefei (CN); Shiwei Wang, Hefei (CN); Xiangming Zhu, Hefei (CN)

(73) Assignee: Zoom Video Communications, Inc., San Jose, CA (US)

(21) Appl. No.: 18/772,895

(22) Filed: Jul. 15, 2024

(51) Int. Cl. H04M 3/56; G10L 15/08

(52) U.S. Cl. CPC H04M 3/568; G10L 15/083

(57) ABSTRACT

Techniques for generating audio streams from modified audio streams and information about the modifications to the audio streams are provided. In an example method, a computing system joins a first client device to a video conference, to which a number of client devices are connected. The computing system receives, from the first client device, a modified first audio stream including information about the modification to the first audio stream. The computing system generates a second audio stream using the modified first audio stream and the information about the modification to the first audio stream. The computing system outputs the second audio stream.

### FIELD

The present application generally relates to digital audio processing, and more particularly relates to techniques for generating audio streams from modified audio streams and information about the modifications to the audio streams.

### BRIEF DESCRIPTION OF THE DRAWINGS

The accompanying drawings, which are incorporated into and constitute a part of this specification, illustrate one or more certain examples and, together with the description of the example, serve to explain the principles and implementations of the certain examples.

FIG. 1 shows an example system that provides videoconferencing functionality to various client devices, according to some aspects of the present disclosure.

FIG. 2 shows an example system in which a video conference provider provides videoconferencing functionality to various client devices, according to some aspects of the present disclosure.

FIG. 3 shows an example user interface that may be used in some example systems configured for generating audio streams from modified audio streams and information about the modifications to the audio streams, according to some aspects of the present disclosure.

FIG. 4 shows an example of a system for generating audio streams from modified audio streams and information about the modifications to the audio streams, according to some examples of the present disclosure.

FIG. 5 depicts another system for generating audio streams from modified audio streams and information about the modifications to the audio streams, according to some examples of the present disclosure.

FIG. 6 shows an example of a UI for generating audio streams from modified audio streams and information about the modifications to the audio streams, according to some examples of the present disclosure.

FIG. 7 shows a flowchart of an example method for generating audio streams from modified audio streams and information about the modifications to the audio streams, according to some examples of the present disclosure.

FIG. 8 shows a flowchart of an example method for generating audio streams from modified audio streams and information about the modifications to the audio streams, according to some examples of the present disclosure.

FIG. 9 shows an example computing device suitable for use in example systems or methods for providing techniques for generating audio streams from modified audio streams and information about the modifications to the audio streams, according to some aspects of the present disclosure.

### DETAILED DESCRIPTION

Examples are described herein in the context of techniques for generating audio streams from modified audio streams and information about the modifications to the audio streams. Those of ordinary skill in the art will realize that the following description is illustrative only and is not intended to be in any way limiting. Reference will now be made in detail to implementations of examples as illustrated in the accompanying drawings. The same reference indicators will be used throughout the drawings and the following description to refer to the same or like items.

In the interest of clarity, not all of the routine features of the examples described herein are shown and described. It will, of course, be appreciated that in the development of any such actual implementation, numerous implementation-specific decisions must be made in order to achieve the developer's specific goals, such as compliance with application-and business-related constraints, and that these specific goals will vary from one implementation to another and from one developer to another.

Video conferencing is a pillar among personal and enterprise communications tools. With the continuing growth of video conferencing as a vital communication medium comes growing expectations that the quality and fidelity of audio and video content of video conferences will be both high and reliable. The same expectations increasingly apply to the constellation of products derived from video conferencing such as translations, transcriptions, and so on.

As a result, digital audio streams used during video conferences are often modified by existing systems through the processing of the received audio to improve the user experience of the recipients of the audio stream. For example, a video conference participant speaking in an environment with loud background noise can benefit from noise suppression of their outgoing audio stream. In another example, a video conference participant may experience undesirable echo effects due to local acoustic effects or the relative placement of speakers and microphones. Such audio streams can be improved using acoustic echo cancellation.

While these and other audio processing techniques can benefit video conference attendees, these existing techniques modify the input digital audio streams in ways that may be detrimental for some downstream applications or other consumers. For example, automatic speech recognition (“ASR”) services may be less accurate when transcribing an audio stream to which a noise suppression algorithm has been applied. Other systems such as voice authentication systems or language translation services may be similarly adversely affected through noise suppression or other modifications to the input audio streams.

Compounding these difficulties further, audio processing may involve irreversibly changing the input audio stream. For example, an input audio stream received through an analog microphone may be converted to a digital format and then processed using noise suppression, acoustic echo cancellation, or other processing steps. At each step, the audio stream may be irreversibly modified (e.g., a copy of the input audio stream to the noise suppression component may not be saved or otherwise persisted). Certain downstream applications may require substantially unmodified version of the processed audio stream to function optimally. Using existing systems, the unmodified audio stream may be irrecoverably lost. Similarly, if both modified and unmodified versions of the input audio stream are needed for multiple downstream applications, existing systems only allow for selection of one or the other, resulting in a poor user experience or unoptimized execution for some, but not all applications.

These difficulties can be addressed using systems and methods for generating audio streams from modified audio streams and information about the modifications to the audio streams. For example, during processing of an input audio stream, a representation of the modifications made during processing can be sent along with the modified audio stream to a remote server. If an application that requires the unmodified audio stream is later used, the substantially unmodified audio stream can be recovered using the modified audio stream and the representation of the modifications made during processing. An unmodified audio stream can thus be approximated using the modified audio stream and the representation.

The following non-limiting example is provided to introduce certain concepts. In the example method, a video conference provider joins a first client device to a video conference to which a number of client devices may be connected. The client device may receive audio input, such as the voice of a participant speaking to the other participants via a microphone. The client device may then convert the incoming audio to a digital input audio stream and apply one or more audio pre-processing steps to the input audio stream. For instance, the first client device may apply a noise suppression algorithm to the input audio stream.

The video conference provider receives, from the client device, the modified (e.g., noise-suppressed) audio stream including information about the modification to the first audio stream. For example, the video conference provider may receive both the modified audio stream as well as additional “extension data” that is representative of the modification (e.g., an audio stream of the suppressed noise). The video conference provider may then distribute the modified audio stream to the other participants, with noise-suppressed audio, resulting in a good user experience.

Given both the modified audio stream as well as the extension data representative of the modification, the video conference provider can also generate a second audio stream using the modified audio stream and the extension data. For example, the video conference provider can reconstruct a substantially unmodified version of the original (unmodified) input audio stream. For instance, if the data representative of the modification is an audio stream of the suppressed noise, the modified audio stream and the audio stream of the suppressed noise can be combined to generate a substantially unmodified version of the original input audio stream.

The video conference provider can then output the substantially unmodified version of the original input audio stream to downstream applications such as automatic speech recognition (“ASR”) services, translation services, voice authentication services, and so on. Because the audio stream is substantially unmodified, these services can achieve an optimized performance.

Systems and methods according to the present disclosure provide significant improvements in the technical field of digital audio processing. Existing approaches required a compromise between user experience and other downstream with differing audio input needs. Examples according to the present disclosure enable both aims to be achieved simultaneously: user experience can be optimized through audio processing and downstream services that perform best with unmodified audio can receive the substantially unmodified input audio. Consequently, the effectiveness and accuracy of a suite of downstream consumers (translation, transcription, authentication, etc.) are improved.

Moreover, the consumption of computing resources can be reduced using the techniques disclosed herein. Previous approaches required persisting the unmodified audio streams to accomplish the same improvements. This need to persist input audio streams is diminished when generating audio streams from modified audio streams and information about the modifications to the audio streams, reducing the consumption of persistent storage. Previous approaches that required both modified and unmodified audio may involve sending two separate audio streams. Using these techniques, both applications can be accommodated with a single audio stream, effectively halving the consumption of network bandwidth.

These illustrative examples are given to introduce the reader to the general subject matter discussed herein and the disclosure is not limited to these examples. The following sections describe various additional non-limiting examples of techniques for generating audio streams from modified audio streams and information about the modifications to the audio streams.

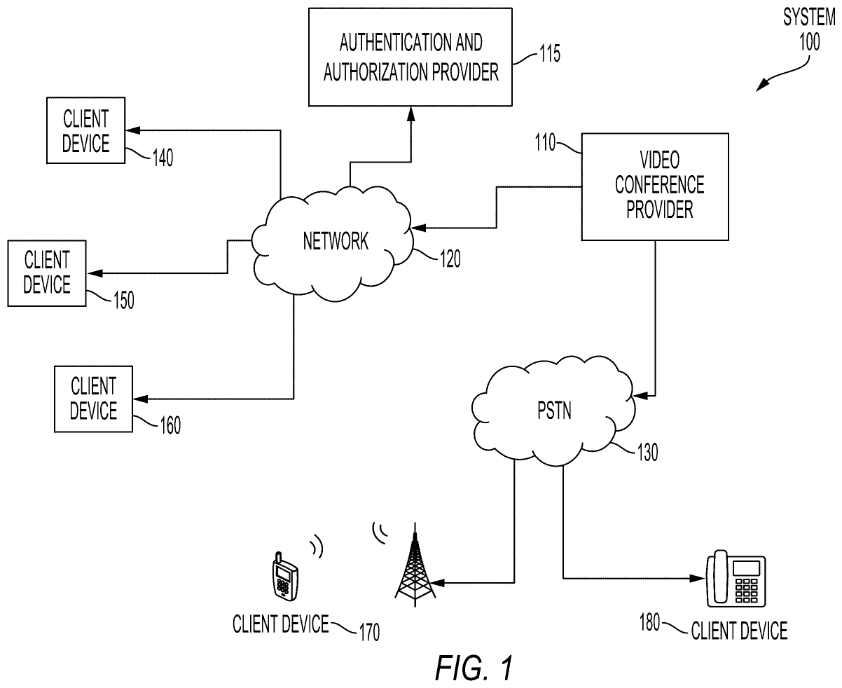

Referring now to FIG. 1, FIG. 1 shows an example system 100 that provides videoconferencing functionality to various client devices. The system 100 includes a video conference provider 110 that is connected to multiple communication networks 120, 130, through which various client devices 140-180 can participate in video conferences hosted by the chat and video conference provider 110. For example, the chat and video conference provider 110 can be located within a private network to provide video conferencing services to devices within the private network, or it can be connected to a public network, e.g., the internet, so it may be accessed by anyone. Some examples may even provide a hybrid model in which a video conference provider 110 may supply components to enable a private organization to host private internal video conferences or to connect its system to the chat and video conference provider 110 over a public network.

The system optionally also includes one or more user identity providers, e.g., user identity provider 115, which can provide user identity services to users of the client devices 140-160 and may authenticate user identities of one or more users to the chat and video conference provider 110. In this example, the user identity provider 115 is operated by a different entity than the chat and video conference provider 110, though in some examples, they may be the same entity.

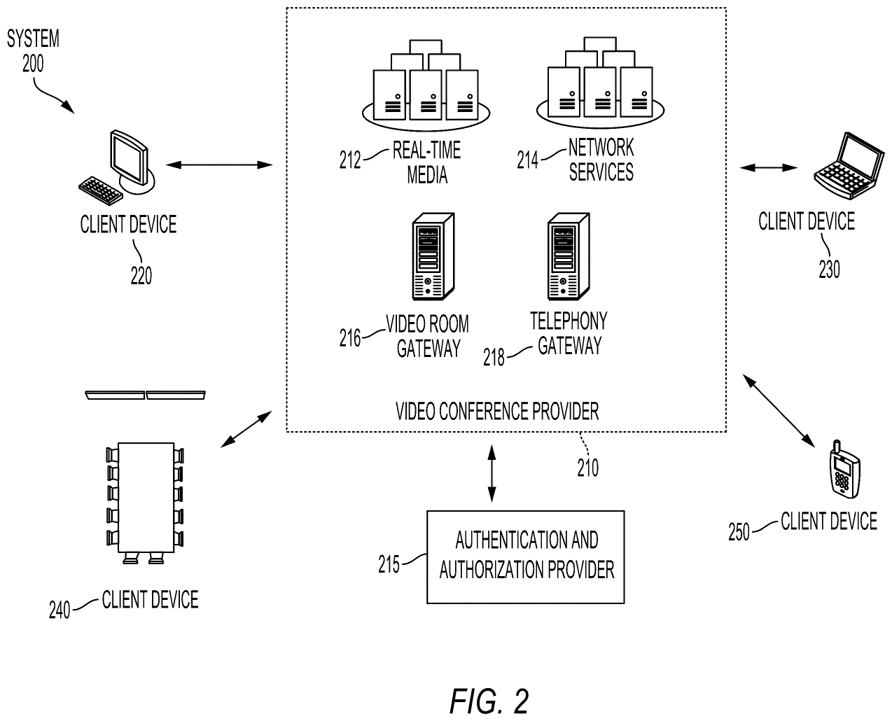

Video conference provider 110 allows clients to create videoconference meetings (or “meetings”) and invite others to participate in those meetings as well as perform other related functionality, such as recording the meetings, generating transcripts from meeting audio, generating summaries and translations from meeting audio, manage user functionality in the meetings, enable text messaging during the meetings, create and manage breakout rooms from the virtual meeting, etc. FIG. 2, described below, provides a more detailed description of the architecture and functionality of the chat and video conference provider 110. It should be understood that the term “meeting” encompasses the term “webinar” used herein.

Meetings in this example video conference provider 110 are provided in virtual rooms to which participants are connected. The room in this context is a construct provided by a server that provides a common point at which the various video and audio data is received before being multiplexed and provided to the various participants. While a “room” is the label for this concept in this disclosure, any suitable functionality that enables multiple participants to participate in a common videoconference may be used.

To create a meeting with the chat and video conference provider 110, a user may contact the chat and video conference provider 110 using a client device 140-180 and select an option to create a new meeting. Such an option may be provided in a webpage accessed by a client device 140-160 or a client application executed by a client device 140-160. For telephony devices, the user may be presented with an audio menu that they may navigate by pressing numeric buttons on their telephony device. To create the meeting, the chat and video conference provider 110 may prompt the user for certain information, such as a date, time, and duration for the meeting, a number of participants, a type of encryption to use, whether the meeting is confidential or open to the public, etc. After receiving the various meeting settings, the chat and video conference provider may create a record for the meeting and generate a meeting identifier and, in some examples, a corresponding meeting password or passcode (or other authentication information), all of which meeting information is provided to the meeting host.

After receiving the meeting information, the user may distribute the meeting information to one or more users to invite them to the meeting. To begin the meeting at the scheduled time (or immediately, if the meeting was set for an immediate start), the host provides the meeting identifier and, if applicable, corresponding authentication information (e.g., a password or passcode). The video conference system then initiates the meeting and may admit users to the meeting. Depending on the options set for the meeting, the users may be admitted immediately upon providing the appropriate meeting identifier (and authentication information, as appropriate), even if the host has not yet arrived, or the users may be presented with information indicating that the meeting has not yet started, or the host may be required to specifically admit one or more of the users.

During the meeting, the participants may employ their client devices 140-180 to capture audio or video information and stream that information to the chat and video conference provider 110. They also receive audio or video information from the chat and video conference provider 110, which is displayed by the respective client device 140 to enable the various users to participate in the meeting.

At the end of the meeting, the host may select an option to terminate the meeting, or it may terminate automatically at a scheduled end time or after a predetermined duration. When the meeting terminates, the various participants are disconnected from the meeting, and they will no longer receive audio or video streams for the meeting (and will stop transmitting audio or video streams). The chat and video conference provider 110 may also invalidate the meeting information, such as the meeting identifier or password/passcode.

To provide such functionality, one or more client devices 140-180 may communicate with the chat and video conference provider 110 using one or more communication networks, such as network 120 or the public switched telephone network (“PSTN”) 130. The client devices 140-180 may be any suitable computing or communication devices that have audio or video capability. For example, client devices 140-160 may be conventional computing devices, such as desktop or laptop computers having processors and computer-readable media, connected to the chat and video conference provider 110 using the internet or other suitable computer network. Suitable networks include the internet, any local area network (“LAN”), metro area network (“MAN”), wide area network (“WAN”), cellular network (e.g., 3G, 4G, 4G LTE, 5G, etc.), or any combination of these. Other types of computing devices may be used instead or as well, such as tablets, smartphones, and dedicated video conferencing equipment. Each of these devices may provide both audio and video capabilities and may enable one or more users to participate in a video conference meeting hosted by the chat and video conference provider 110.

In addition to the computing devices discussed above, client devices 140-180 may also include one or more telephony devices, such as cellular telephones (e.g., cellular telephone 170), internet protocol (“IP”) phones (e.g., telephone 180), or conventional telephones. Such telephony devices may allow a user to make conventional telephone calls to other telephony devices using the PSTN, including the chat and video conference provider 110. It should be appreciated that certain computing devices may also provide telephony functionality and may operate as telephony devices. For example, smartphones typically provide cellular telephone capabilities and thus may operate as telephony devices in the example system 100 shown in FIG. 1. In addition, conventional computing devices may execute software to enable telephony functionality, which may allow the user to make and receive phone calls, e.g., using a headset and microphone. Such software may communicate with a PSTN gateway to route the call from a computer network to the PSTN. Thus, telephony devices encompass any devices that can make conventional telephone calls and are not limited solely to dedicated telephony devices like conventional telephones.

Referring again to client devices 140-160, these devices 140-160 contact the chat and video conference provider 110 using network 120 and may provide information to the chat and video conference provider 110 to access functionality provided by the chat and video conference provider 110, such as access to create new meetings or join existing meetings. To do so, the client devices 140-160 may provide user identification information, meeting identifiers, meeting passwords or passcodes, etc. In examples that employ a user identity provider 115, a client device, e.g., client devices 140-160, may operate in conjunction with a user identity provider 115 to provide user identification information or other user information to the chat and video conference provider 110.

A user identity provider 115 may be any entity trusted by the chat and video conference provider 110 that can help identify a user to the chat and video conference provider 110. For example, a trusted entity may be a server operated by a business or other organization with whom the user has established their identity, such as an employer or trusted third-party. The user may sign into the user identity provider 115, such as by providing a username and password, to access their identity at the user identity provider 115. The identity, in this sense, is information established and maintained at the user identity provider 115 that can be used to identify a particular user, irrespective of the client device they may be using. An example of an identity may be an email account established at the user identity provider 115 by the user and secured by a password or additional security features, such as two-factor authentication. However, identities may be distinct from functionality such as email. For example, a health care provider may establish identities for its patients. And while such identities may have associated email accounts, the identity is distinct from those email accounts. Thus, a user's “identity” relates to a secure, verified set of information that is tied to a particular user and should be accessible only by that user. By accessing the identity, the associated user may then verify themselves to other computing devices or services, such as the chat and video conference provider 110.

When the user accesses the chat and video conference provider 110 using a client device, the chat and video conference provider 110 communicates with the user identity provider 115 using information provided by the user to verify the user's identity. For example, the user may provide a username or cryptographic signature associated with a user identity provider 115. The user identity provider 115 then either confirms the user's identity or denies the request. Based on this response, the chat and video conference provider 110 either provides or denies access to its services, respectively.

For telephony devices, e.g., client devices 170-180, the user may place a telephone call to the chat and video conference provider 110 to access video conference services. After the call is answered, the user may provide information regarding a video conference meeting, e.g., a meeting identifier (“ID”), a passcode or password, etc., to allow the telephony device to join the meeting and participate using audio devices of the telephony device, e.g., microphone(s) and speaker(s), even if video capabilities are not provided by the telephony device.

Because telephony devices typically have more limited functionality than conventional computing devices, they may be unable to provide certain information to the chat and video conference provider 110. For example, telephony devices may be unable to provide user identification information to identify the telephony device or the user to the chat and video conference provider 110. Thus, the chat and video conference provider 110 may provide more limited functionality to such telephony devices. For example, the user may be permitted to join a meeting after providing meeting information, e.g., a meeting identifier and passcode, but they may be identified only as an anonymous participant in the meeting. This may restrict their ability to interact with the meetings in some examples, such as by limiting their ability to speak in the meeting, hear or view certain content shared during the meeting, or access other meeting functionality, such as joining breakout rooms or engaging in text chat with other participants in the meeting.

It should be appreciated that users may choose to participate in meetings anonymously and decline to provide user identification information to the chat and video conference provider 110, even in cases where the user has an authenticated identity and employs a client device capable of identifying the user to the chat and video conference provider 110. The chat and video conference provider 110 may determine whether to allow such anonymous users to use services provided by the chat and video conference provider 110. Anonymous users, regardless of the reason for anonymity, may be restricted as discussed above with respect to users employing telephony devices, and in some cases may be prevented from accessing certain meetings or other services, or may be entirely prevented from accessing the chat and video conference provider 110.

Referring again to video conference provider 110, in some examples, it may allow client devices 140-160 to encrypt their respective video and audio streams to help improve privacy in their meetings. Encryption may be provided between the client devices 140-160 and the chat and video conference provider 110 or it may be provided in an end-to-end configuration where multimedia streams (e.g., audio or video streams) transmitted by the client devices 140-160 are not decrypted until they are received by another client device 140-160 participating in the meeting. Encryption may also be provided during only a portion of a communication, for example encryption may be used for otherwise unencrypted communications that cross international borders.

Client-to-server encryption may be used to secure the communications between the client devices 140-160 and the chat and video conference provider 110, while allowing the chat and video conference provider 110 to access the decrypted multimedia streams to perform certain processing, such as recording the meeting for the participants or generating transcripts of the meeting for the participants. End-to-end encryption may be used to keep the meeting entirely private to the participants without any worry about a video conference provider 110 having access to the substance of the meeting. Any suitable encryption methodology may be employed, including key-pair encryption of the streams. For example, to provide end-to-end encryption, the meeting host's client device may obtain public keys for each of the other client devices participating in the meeting and securely exchange a set of keys to encrypt and decrypt multimedia content transmitted during the meeting. Thus, the client devices 140-160 may securely communicate with each other during the meeting. Further, in some examples, certain types of encryption may be limited by the types of devices participating in the meeting. For example, telephony devices may lack the ability to encrypt and decrypt multimedia streams. Thus, while encrypting the multimedia streams may be desirable in many instances, it is not required as it may prevent some users from participating in a meeting.

By using the example system shown in FIG. 1, users can create and participate in meetings using their respective client devices 140-180 via the chat and video conference provider 110. Further, such a system enables users to use a wide variety of different client devices 140-180 from traditional standards-based video conferencing hardware to dedicated video conferencing equipment to laptop or desktop computers to handheld devices to legacy telephony devices. etc.

Referring now to FIG. 2, FIG. 2 shows an example system 200 in which a video conference provider 210 provides videoconferencing functionality to various client devices 220-250. The client devices 220-250 include two conventional computing devices 220-230, dedicated equipment for a video conference room 240, and a telephony device 250. Each client device 220-250 communicates with the chat and video conference provider 210 over a communications network, such as the internet for client devices 220-240 or the PSTN for client device 250, generally as described above with respect to FIG. 1. The chat and video conference provider 210 is also in communication with one or more user identity providers 215, which can authenticate various users to the chat and video conference provider 210 generally as described above with respect to FIG. 1.

In this example, the chat and video conference provider 210 employs multiple different servers (or groups of servers) to provide different examples of video conference functionality, thereby enabling the various client devices to create and participate in video conference meetings. The chat and video conference provider 210 uses one or more real-time media servers 212, one or more network services servers 214, one or more video room gateways 216, one or more message and presence gateways 217, and one or more telephony gateways 218. Each of these servers 212-218 is connected to one or more communications networks to enable them to collectively provide access to and participation in one or more video conference meetings to the client devices 220-250.

The real-time media servers 212 provide multiplexed multimedia streams to meeting participants, such as the client devices 220-250 shown in FIG. 2. While video and audio streams typically originate at the respective client devices, they are transmitted from the client devices 220-250 to the chat and video conference provider 210 via one or more networks where they are received by the real-time media servers 212. The real-time media servers 212 determine which protocol is optimal based on, for example, proxy settings and the presence of firewalls, etc. For example, the client device might select among UDP, TCP, TLS, or HTTPS for audio and video and UDP for content screen sharing.

The real-time media servers 212 then multiplex the various video and audio streams based on the target client device and communicate multiplexed streams to each client device. For example, the real-time media servers 212 receive audio and video streams from client devices 220-240 and only an audio stream from client device 250. The real-time media servers 212 then multiplex the streams received from devices 230-250 and provide the multiplexed stream to client device 220. The real-time media servers 212 are adaptive, for example, reacting to real-time network and client changes, in how they provide these streams. For example, the real-time media servers 212 may monitor parameters such as a client's bandwidth CPU usage, memory and network I/O as well as network parameters such as packet loss, latency and jitter to determine how to modify the way in which streams are provided.

The client device 220 receives the stream, performs any decryption, decoding, and demultiplexing on the received streams, and then outputs the audio and video using the client device's video and audio devices. In this example, the real-time media servers do not multiplex client device 220′s own video and audio feeds when transmitting streams to it. Instead, each client device 220-250 only receives multimedia streams from other client devices 220-250. For telephony devices that lack video capabilities, e.g., client device 250, the real-time media servers 212 only deliver multiplex audio streams. The client device 220 may receive multiple streams for a particular communication, allowing the client device 220 to switch between streams to provide a higher quality of service.

In addition to multiplexing multimedia streams, the real-time media servers 212 may also decrypt incoming multimedia stream in some examples. As discussed above, multimedia streams may be encrypted between the client devices 220-250 and the chat and video conference provider 210. In some such examples, the real-time media servers 212 may decrypt incoming multimedia streams, multiplex the multimedia streams appropriately for the various clients, and encrypt the multiplexed streams for transmission.

As mentioned above with respect to FIG. 1, the chat and video conference provider 210 may provide certain functionality with respect to unencrypted multimedia streams at a user's request. For example, the meeting host may be able to request that the meeting be recorded or that a transcript of the audio streams be prepared, which may then be performed by the real-time media servers 212 using the decrypted multimedia streams, or the recording or transcription functionality may be off-loaded to a dedicated server (or servers), e.g., cloud recording servers, for recording the audio and video streams. In some examples, the chat and video conference provider 210 may allow a meeting participant to notify it of inappropriate behavior or content in a meeting. Such a notification may trigger the real-time media servers to 212 record a portion of the meeting for review by the chat and video conference provider 210. Still other functionality may be implemented to take actions based on the decrypted multimedia streams at the chat and video conference provider, such as monitoring video or audio quality, adjusting or changing media encoding mechanisms, etc.

It should be appreciated that multiple real-time media servers 212 may be involved in communicating data for a single meeting and multimedia streams may be routed through multiple different real-time media servers 212. In addition, the various real-time media servers 212 may not be co-located, but instead may be located at multiple different geographic locations, which may enable high-quality communications between clients that are dispersed over wide geographic areas, such as being located in different countries or on different continents. Further, in some examples, one or more of these servers may be co-located on a client's premises, e.g., at a business or other organization. For example, different geographic regions may each have one or more real-time media servers 212 to enable client devices in the same geographic region to have a high-quality connection into the chat and video conference provider 210 via local servers 212 to send and receive multimedia streams, rather than connecting to a real-time media server located in a different country or on a different continent. The local real-time media servers 212 may then communicate with physically distant servers using high-speed network infrastructure, e.g., internet backbone network(s), that otherwise might not be directly available to client devices 220-250 themselves. Thus, routing multimedia streams may be distributed throughout the video conference system 210 and across many different real-time media servers 212.

Turning to the network services servers 214, these servers 214 provide administrative functionality to enable client devices to create or participate in meetings, send meeting invitations, create or manage user accounts or subscriptions, and other related functionality. Further, these servers may be configured to perform different functionalities or to operate at different levels of a hierarchy, e.g., for specific regions or localities, to manage portions of the chat and video conference provider under a supervisory set of servers. When a client device 220-250 accesses the chat and video conference provider 210, it will typically communicate with one or more network services servers 214 to access their account or to participate in a meeting.

When a client device 220-250 first contacts the chat and video conference provider 210 in this example, it is routed to a network services server 214. The client device may then provide access credentials for a user, e.g., a username and password or single sign-on credentials, to gain authenticated access to the chat and video conference provider 210. This process may involve the network services servers 214 contacting a user identity provider 215 to verify the provided credentials. Once the user's credentials have been accepted, the network services servers 214 may perform administrative functionality, like updating user account information, if the user has an identity with the chat and video conference provider 210, or scheduling a new meeting, by interacting with the network services servers 214.

In some examples, users may access the chat and video conference provider 210 anonymously. When communicating anonymously, a client device 220-250 may communicate with one or more network services servers 214 but only provide information to create or join a meeting, depending on what features the chat and video conference provider allows for anonymous users. For example, an anonymous user may access the chat and video conference provider using client device 220 and provide a meeting ID and passcode. The network services server 214 may use the meeting ID to identify an upcoming or on-going meeting and verify the passcode is correct for the meeting ID. After doing so, the network services server(s) 214 may then communicate information to the client device 220 to enable the client device 220 to join the meeting and communicate with appropriate real-time media servers 212.

In cases where a user wishes to schedule a meeting, the user (anonymous or authenticated) may select an option to schedule a new meeting and may then select various meeting options, such as the date and time for the meeting, the duration for the meeting, a type of encryption to be used, one or more users to invite, privacy controls (e.g., not allowing anonymous users, preventing screen sharing, manually authorize admission to the meeting, etc.), meeting recording options, etc. The network services servers 214 may then create and store a meeting record for the scheduled meeting. When the scheduled meeting time arrives (or within a threshold period of time in advance), the network services server(s) 214 may accept requests to join the meeting from various users.

To handle requests to join a meeting, the network services server(s) 214 may receive meeting information, such as a meeting ID and passcode, from one or more client devices 220-250. The network services server(s) 214 locate a meeting record corresponding to the provided meeting ID and then confirm whether the scheduled start time for the meeting has arrived, whether the meeting host has started the meeting, and whether the passcode matches the passcode in the meeting record. If the request is made by the host, the network services server(s) 214 activates the meeting and connects the host to a real-time media server 212 to enable the host to begin sending and receiving multimedia streams.

Once the host has started the meeting, subsequent users requesting access will be admitted to the meeting if the meeting record is located and the passcode matches the passcode supplied by the requesting client device 220-250. In some examples additional access controls may be used as well. But if the network services server(s) 214 determines to admit the requesting client device 220-250 to the meeting, the network services server 214 identifies a real-time media server 212 to handle multimedia streams to and from the requesting client device 220-250 and provides information to the client device 220-250 to connect to the identified real-time media server 212. Additional client devices 220-250 may be added to the meeting as they request access through the network services server(s) 214.

After joining a meeting, client devices will send and receive multimedia streams via the real-time media servers 212, but they may also communicate with the network services servers 214 as needed during meetings. For example, if the meeting host leaves the meeting, the network services server(s) 214 may appoint another user as the new meeting host and assign host administrative privileges to that user. Hosts may have administrative privileges to allow them to manage their meetings, such as by enabling or disabling screen sharing, muting or removing users from the meeting, assigning or moving users to the mainstage or a breakout room if present, recording meetings, etc. Such functionality may be managed by the network services server(s) 214.

For example, if a host wishes to remove a user from a meeting, they may identify the user and issue a command through a user interface on their client device. The command may be sent to a network services server 214, which may then disconnect the identified user from the corresponding real-time media server 212. If the host wishes to remove one or more participants from a meeting, such a command may also be handled by a network services server 214, which may terminate the authorization of the one or more participants for joining the meeting.

In addition to creating and administering on-going meetings, the network services server(s) 214 may also be responsible for closing and tearing-down meetings once they have been completed. For example, the meeting host may issue a command to end an on-going meeting, which is sent to a network services server 214. The network services server 214 may then remove any remaining participants from the meeting, communicate with one or more real time media servers 212 to stop streaming audio and video for the meeting, and deactivate, e.g., by deleting a corresponding passcode for the meeting from the meeting record, or delete the meeting record(s) corresponding to the meeting. Thus, if a user later attempts to access the meeting, the network services server(s) 214 may deny the request.

Depending on the functionality provided by the chat and video conference provider, the network services server(s) 214 may provide additional functionality, such as by providing private meeting capabilities for organizations, special types of meetings (e.g., webinars), etc. Such functionality may be provided according to various examples of video conferencing providers according to this description.

Referring now to the video room gateway servers 216, these servers 216 provide an interface between dedicated video conferencing hardware, such as may be used in dedicated video conferencing rooms. Such video conferencing hardware may include one or more cameras and microphones and a computing device designed to receive video and audio streams from each of the cameras and microphones and connect with the chat and video conference provider 210. For example, the video conferencing hardware may be provided by the chat and video conference provider to one or more of its subscribers, which may provide access credentials to the video conferencing hardware to use to connect to the chat and video conference provider 210.

The video room gateway servers 216 provide specialized authentication and communication with the dedicated video conferencing hardware that may not be available to other client devices 220-230, 250. For example, the video conferencing hardware may register with the chat and video conference provider when it is first installed and the video room gateway may authenticate the video conferencing hardware using such registration as well as information provided to the video room gateway server(s) 216 when dedicated video conferencing hardware connects to it, such as device ID information, subscriber information, hardware capabilities, hardware version information etc. Upon receiving such information and authenticating the dedicated video conferencing hardware, the video room gateway server(s) 216 may interact with the network services servers 214 and real-time media servers 212 to allow the video conferencing hardware to create or join meetings hosted by the chat and video conference provider 210.

Referring now to the telephony gateway servers 218, these servers 218 enable and facilitate telephony devices' participation in meetings hosted by the chat and video conference provider 210. Because telephony devices communicate using the PSTN and not using computer networking protocols, such as TCP/IP, the telephony gateway servers 218 act as an interface that converts between the PSTN, and the networking system used by the chat and video conference provider 210.

For example, if a user uses a telephony device to connect to a meeting, they may dial a phone number corresponding to one of the chat and video conference provider's telephony gateway servers 218. The telephony gateway server 218 will answer the call and generate audio messages requesting information from the user, such as a meeting ID and passcode. The user may enter such information using buttons on the telephony device, e.g., by sending dual-tone multi-frequency (“DTMF”) audio streams to the telephony gateway server 218. The telephony gateway server 218 determines the numbers or letters entered by the user and provides the meeting ID and passcode information to the network services servers 214, along with a request to join or start the meeting, generally as described above. Once the telephony client device 250 has been accepted into a meeting, the telephony gateway server is instead joined to the meeting on the telephony device's behalf.

After joining the meeting, the telephony gateway server 218 receives an audio stream from the telephony device and provides it to the corresponding real-time media server 212 and receives audio streams from the real-time media server 212, decodes them, and provides the decoded audio to the telephony device. Thus, the telephony gateway servers 218 operate essentially as client devices, while the telephony device operates largely as an input/output device, e.g., a microphone and speaker, for the corresponding telephony gateway server 218, thereby enabling the user of the telephony device to participate in the meeting despite not using a computing device or video.

It should be appreciated that the components of the chat and video conference provider 210 discussed above are merely examples of such devices and an example architecture. Some video conference providers may provide more or less functionality than described above and may not separate functionality into different types of servers as discussed above. Instead, any suitable servers and network architectures may be used according to different examples.

In some embodiments, in addition to the video conferencing functionality described above, the chat and video conference provider 210 (or the chat and video conference provider 110) may provide a chat functionality. Chat functionality may be implemented using a message and presence protocol and coordinated by way of a message and presence gateway 217. In such examples, the chat and video conference provider 210 may allow a user to create one or more chat channels where the user may exchange messages with other users (e.g., members) that have access to the chat channel(s). The messages may include text, image files, video files, or other files. In some examples, a chat channel may be “open,” meaning that any user may access the chat channel. In other examples, the chat channel may require that a user be granted permission to access the chat channel. The chat and video conference provider 210 may provide permission to a user and/or an owner of the chat channel may provide permission to the user. Furthermore, there may be any number of members permitted in the chat channel.

Similar to the formation of a meeting, a chat channel may be provided by a server where messages exchanged between members of the chat channel are received and then directed to respective client devices. For example, if the client devices 220-250 are part of the same chat channel, messages may be exchanged between the client devices 220-240 via the chat and video conference provider 210 in a manner similar to how a meeting is hosted by the chat and video conference provider 210.

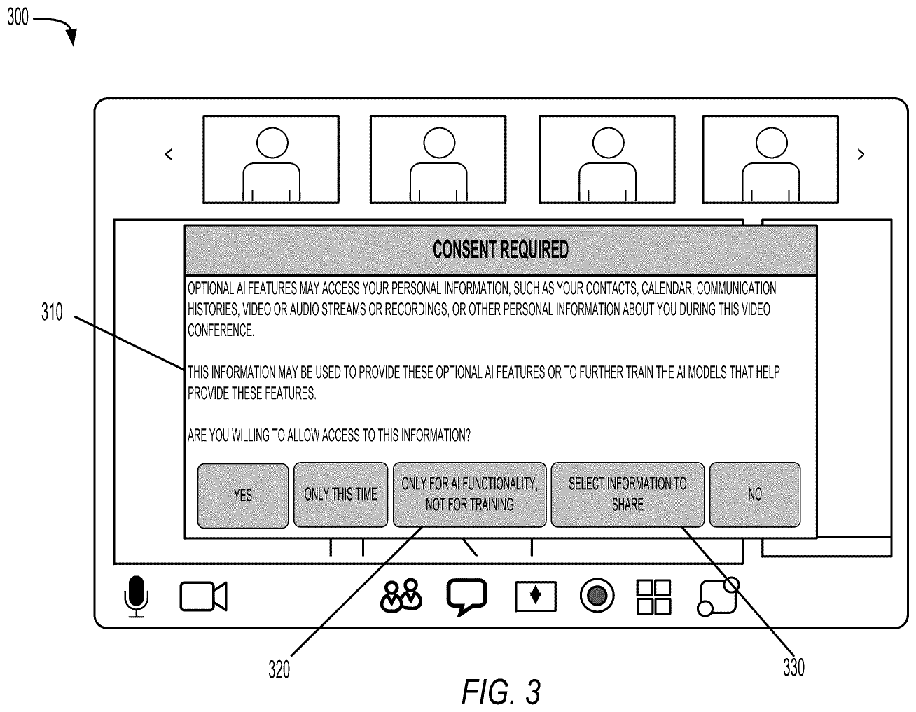

Turning next to FIG. 3, FIG. 3 shows an example user interface 300 that may be used in some example systems configured for generating audio streams from modified audio streams and information about the modifications to the audio streams. In some examples according to the present disclosure, a user may select an option to use one or more optional AI features available from the virtual conference provider 302. The use of these optional AI features may involve providing the user's personal information to the AI models underlying the AI features. The personal information may include the user's contacts, calendar, communication histories, video or audio streams, recordings of the video or audio streams, transcripts of audio or video conferences, or any other personal information available the virtual conference provider. Further, the audio or video feeds may include the user's speech, which includes the user's speaking patterns, cadence, diction, timbre, and pitch; the user's appearance and likeness, which may include facial movements, eye movements, arm or hand movements, and body movements, all of which may be employed to provide the optional AI features or to train the underlying AI models.

Before capturing and using any such information, whether to provide optional AI features or to providing training data for the underlying AI models, the user may be provided with an option to consent, or deny consent, to access and use some or all of the user's personal information. In general, Zoom's goal is to invest in AI-driven innovation that enhances user experience and productivity while prioritizing trust, safety, and privacy. Without the user's explicit, informed consent, the user's personal information will not be used with any AI functionality or as training data for any AI model. Additionally, these optional AI features are turned off by default-account owners and administrators control whether to enable these AI features for their accounts, and if enabled, individual users may determine whether to provide consent to use their personal information.

As can be seen in FIG. 3, a user has engaged in a video conference and has selected an option to use an available optional AI feature. In response, the GUI has displayed a consent authorization window 310 for the user to interact with. The consent authorization window 310 informs the user that their request may involve the optional AI feature accessing multiple different types of information, which may be personal to the user. The user can then decide whether to grant permission or not to the optional AI feature generally, or only in a limited capacity. For example, the user may select an option 320 to only allow the AI functionality to use the personal information to provide the AI functionality, but not for training of the underlying AI models. In addition, the user is presented with the option 330 to select which types of information may be shared and for what purpose, such as to provide the AI functionality or to allow use for training underlying AI models.

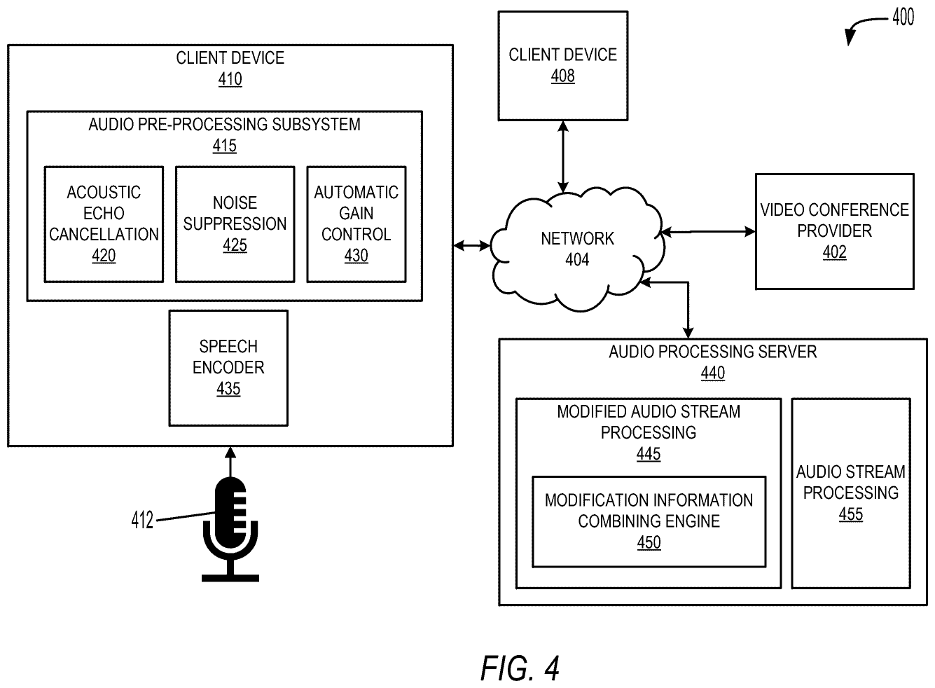

Referring now to FIG. 4, FIG. 4 shows an example of a system 400 for generating audio streams from modified audio streams and information about the modifications to the audio streams, according to some examples of the present disclosure. System 400 includes two client devices 408, 410 communicatively coupled with video conference provider 402 over a network 404. Network 404 may include the Internet, public networks, private networks, or combinations thereof. Video conference provider 402 is typically a server or collection of servers, including a combination of privately or cloud-hosted devices. Video conference provider 402 may be similar, in some respects, to the video conference providers 110, 210 described above with respect to FIGS. 1 and 2.

Client devices 408, 410 may be any type of device capable of executing the appropriate client software for generating audio streams from modified audio streams and information about the modifications to the audio streams. For example, the client devices 408, 410 may be laptops, desktops, smartphones, tablets, internet protocol (IP) phones, and so on. The client devices 408, 410 may execute video conference client software that provides GUIs for interacting with the services provided by the video conference provider 402 such as video conferencing, chat, email, calendaring, whiteboarding, telephony, and so on.

The client devices 408, 410 may have a variety of connected audio input devices. FIG. 4 shows an exploded view of client device 410 to introduce certain concepts. Other example client devices may include similar features as well as variations on the examples disclosed herein. Client device 410 is depicted with a communicatively coupled audio input device 412 depicted as a sketch of a microphone. The audio input device 412 may be an embedded or internal microphone, external microphone, wireless microphone, shared microphone, and so on. The audio input device 412 may be configured to capture video conference audio as an analog or digital signal. However, analog audio input devices 412 require an analog-to-digital conversion (not shown) prior to processing by the audio pre-processing subsystem 415 or other components.

The client device 410 includes an audio pre-processing subsystem 415. Examples of audio pre-processing subsystem 415 can include components for performing various aspects of audio pre-processing. In the example depicted in system 400, audio pre-processing subsystem 415 includes components for acoustic echo cancellation 420, noise suppression 425, and automatic gain control 430. Other audio pre-processing components may include, for example, audio compression, equalization, beamforming, voice activity detection, reverberation removal, and so on.

Acoustic echo cancellation 420 can be configured to remove echo from the input audio stream. Echo may be caused by, for example, audio being played back at a remote audio output device and re-input to the audio input device 412 after a perceptible delay, causing an echo effect to be played back. Acoustic echo cancellation 420 can use, for example, adaptive filtering algorithms to predict and subtract the echo from the audio input. Noise suppression 425 can be configured to identify and reduce background noise while preserving the desired speech signal. Examples of techniques used for noise suppression 425 include spectral subtraction and/or using ML models identify noisy audio prior to modification of the input audio stream. Automatic gain control 430 can be used to adjust the volume of the input audio stream to maintain a consistent volume level by modifying volume variations received as part of the input audio stream. Some examples of automatic gain control 430 may use dynamic amplification or attenuation algorithms to modify the input audio stream.

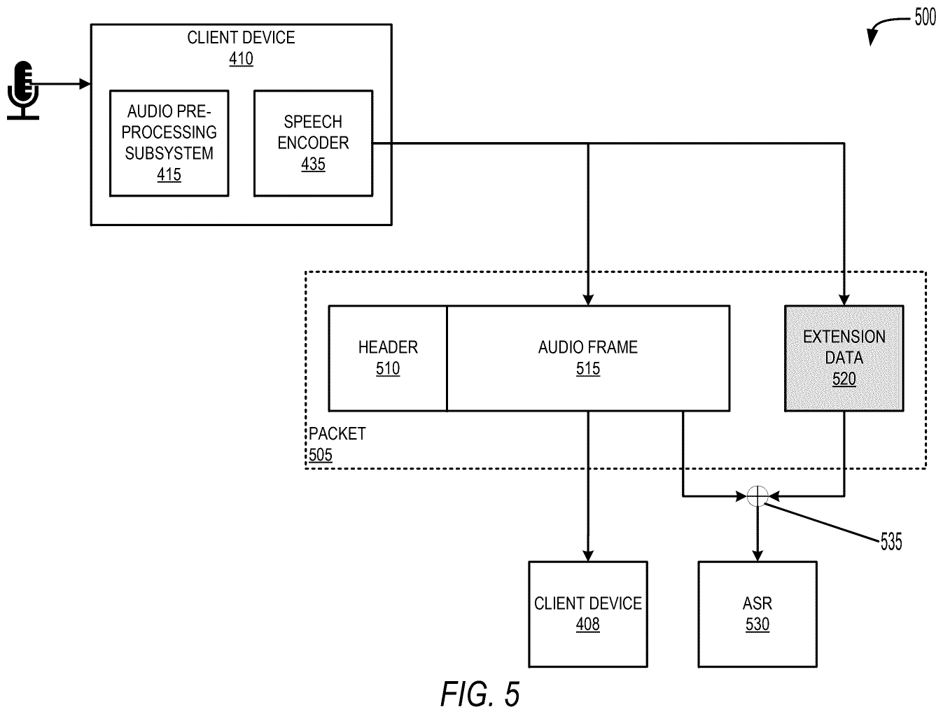

Following pre-processing by the audio pre-processing subsystem 415 of the digital audio stream, the speech encoder 435 generates an audio stream suitable for transmission to the video conference provider 402 over the network 404. For example, the input audio stream may be captured as a continuous audio signal in the WAV format, a data format for representing digital audio data in uncompressed, raw form. Alternatively, the input audio stream may be represented using a compressed digital audio format. The speech encoder 435 can convert the input audio stream into a series of “packets” that encapsulate segments of the input audio stream. Each packet can include a portion of the input modified audio stream, along with additional information about any modifications made to the input audio stream by the audio pre-processing subsystem 415 (e.g., removed noise or echo). Downstream consumers can reassemble the audio stream upon receipt of an ordered collection of such packets. Details, including an example packet, are shown in FIG. 5.

The modified audio stream is sent over the network 404 to the video conference provider 402 for processing and distribution to other client devices 408. System 400 includes audio processing server 440 for processing of the received audio stream. The audio processing server 440 is shown as a standalone component communicatively coupled over network 404, but in some examples may be a component of the video conference provider 402. The audio processing server 440 includes a number of components for processing of modified and unmodified audio stream processing. The components of the audio processing server 440 may be implemented in hardware, software, or a combination thereof. Software components may be hosted on physical servers, virtual machines, cloud computing instances, or a combination thereof. The components of the audio processing server 440 are shown in FIG. 4 grouped together for clarity, but in various examples may include numerous separate, communicatively coupled components.

The audio processing server 440 includes components for modified audio stream processing 445 and audio stream processing 455 for all audio streams. The modified audio stream processing component 445 can be used to generate substantially unmodified versions of the received modified audio stream for downstream consumers that function optimally with unmodified audio (e.g., ASR).

For example, the modified audio stream processing component 445 can receive, from the client device 410, a modified audio stream that includes both the modified audio stream as well as information about the modification. For instance, the modified audio stream may include a number of ordered packets, each including both modified audio data as well as extension data. The modified audio data and extension data can be combined by a modification information combination engine 450 to generate a substantially unmodified audio stream. The modification information combination engine 450 can combine the modified audio stream and the information about the modification using a suitable computation technique including addition, concatenation, interpolation, and so on. For instance, the packets received for the modified audio stream may include modified audio frames and extension data that is audio that was removed from the input audio stream in the same digital audio format. In that case, the modified audio frames and extension data can be added to obtain the unmodified audio stream.

The audio stream processing component 455 can be used for applying additional audio processing for received or reconstructed audio streams before sending the audio to downstream consumers. For instance, the audio stream processing component 455 can re-encode the audio into a suitable format, encrypt the audio stream, perform multiplexing operations for distribution to multiple consumers (e.g., client devices), apply compression, and so on. The audio stream processing component 455 can output the processed audio streams to downstream consumers and services.

Referring now to FIG. 5, FIG. 5 depicts another system 500 for generating audio streams from modified audio streams and information about the modifications to the audio streams, according to some examples of the present disclosure. System 500 includes a schematic diagram of a packet 505 that may be used during transmission of an audio stream. The packet 505 is output from the client device 410 after being generated by the speech encoder 435 or similar component. The audio stream is an example of a data stream, which may be a continuous flow of data transmitted over a network. For instance, an audio stream may include a sequence of audio data “packets” that include addressing and routing information to ensure they reach the correct destination and are reassembled in the proper order. Continuity and ordering among the packets can be ensured using techniques for managing packet sequencing and retransmissions. For example, sequence numbers in each packet can be used by the packet receiver to correctly order received packets, acknowledgment messages can be required to confirm receipt, and missing or corrupted packets can be retransmitted upon request by the receiver.

The packet 505 may be, for example, an Internet Protocol (“IP”) packet. An IP packet is used for routing data across different networks by encapsulating the data payload with addressing information, such as source and destination IP addresses. The encapsulated data payload may be, for example, a Transmission Control Protocol (“TCP”) or User Datagram Protocol (“UDP”) payload. The schematic diagram of FIG. 5 depicts the encapsulated data payload, omitting the IP and other lower-layer (e.g., physical or data link layers) details for clarity. The TCP or UDP payload includes a header 510 and audio frame 515.

An ordered sequence of headers 510 and audio frames 515 constitute an audio stream. Packets 505 may be sent individually, sent multiple times (e.g., redundant copies may be sent), retransmitted, or omitted according to various implementations. The packets 505 may be received by downstream consumers such as client device 408 or ASR 530 after processing by the audio processing server 440 shown in FIG. 4.

The packet 505 includes extension data 520. The extension data 520 can include information about modifications made to the input audio stream. For example, as described with respect to system 400 in FIG. 4 above, the audio pre-processing subsystem 415 can apply a number of pre-processing algorithms to the first audio stream (e.g., acoustic echo cancellation 420, noise suppression 425, automatic gain control 430, etc.). In some cases, application of these pre-processing algorithms modifies the input audio stream to generate a modified audio stream.

For instance, acoustic echo cancellation 420 may eliminate detected echo noise from the input audio stream; noise suppression 425 can eliminate detected background noise from the input audio stream; or automatic gain control 430 can change magnitude of certain input audio signals past maximum saturation or below minimum playable volume levels. In each case, as well as other examples of pre-processing, the input audio stream may be irreversibly modified. In this respect, “irreversibly” means that the modified audio stream cannot be reverted to its unmodified form without additional information (i.e., using the modified audio stream alone).

The audio pre-processing subsystem 415 can generate the information about the modifications to the input audio stream as the modifications are applied during pre-processing. The speech encoder can be then include the information about the modifications to the input audio stream as extension data 520, an algorithm such as spectral subtraction can be used to determine and remove background noise. The estimated noise, also referred to as the over-suppressed portion of the input audio stream, can be subtracted from the input audio stream during application of the algorithm. The estimated noise can be persisted as a separate audio stream, which can be included in the packet 505 as extension data 520. In this example, the estimated noise or over-suppressed portion of the input to the Audio Streams audio stream, represents the difference between the unmodified input audio stream and the modified audio stream. The information about the modifications to the input audio stream may use any suitable format including text-based formats, binary formats, compressed or encrypted formats, and so on.

The modified audio stream, including packet 505, can be received by downstream consumers such as another client device 408 or ASR component 530 (intermediate components such as video conference provider 402 or audio processing server 440 are not shown for clarity). The downstream consumers may have differing requirements for input for optimized performance. For instance, the user of the client device 408 may desire to hear playback of the input audio stream from client device 410 with the pre-processing of audio pre-processing subsystem 415 applied for the clearest, crispest voice signal at a palatable volume level.

In contrast, the ASR component 530 may be able to achieve optimized performance generating text from speech only when all portions of the input audio stream are available (e.g., the unmodified input audio stream). For this purpose, for each packet 505, the audio frame 515 and extension data 520 can be combined at 535 to reproduce the substantially unmodified audio stream. For instance, a component such as the modified audio stream processing component 445 can perform the combination 535. The ASR component 530 then receives the substantially unmodified audio stream and can achieve optimized performance for transcribing speech to text.

Substantially unmodified audio stream refers generally to the audio stream obtained through a combination of a number of audio frames 515 and corresponding extension data 520. In some examples, recreation of the identical input audio stream may not be possible due to factors such as the use of compression, pre-processing algorithms that do not generate an exact difference (e.g., one-way mathematical transformations), dropped packets, and so on. The combination at 535 combines the audio frames 515 and corresponding extension data 520 using computational techniques configured to reproduce the unmodified audio stream with a high degree of fidelity which may not, in all cases, be an identical copy. Thus, the recreated audio stream can be generated to approximate an unmodified input audio stream.

In addition to the ASR component 530, other examples of components that may be preferentially used with the unmodified audio stream include components for speaker identification, language identification, accent identification, voice command or interactive voice response (“IVR”) systems, translation services, forensic audio analysis tools, and so on.

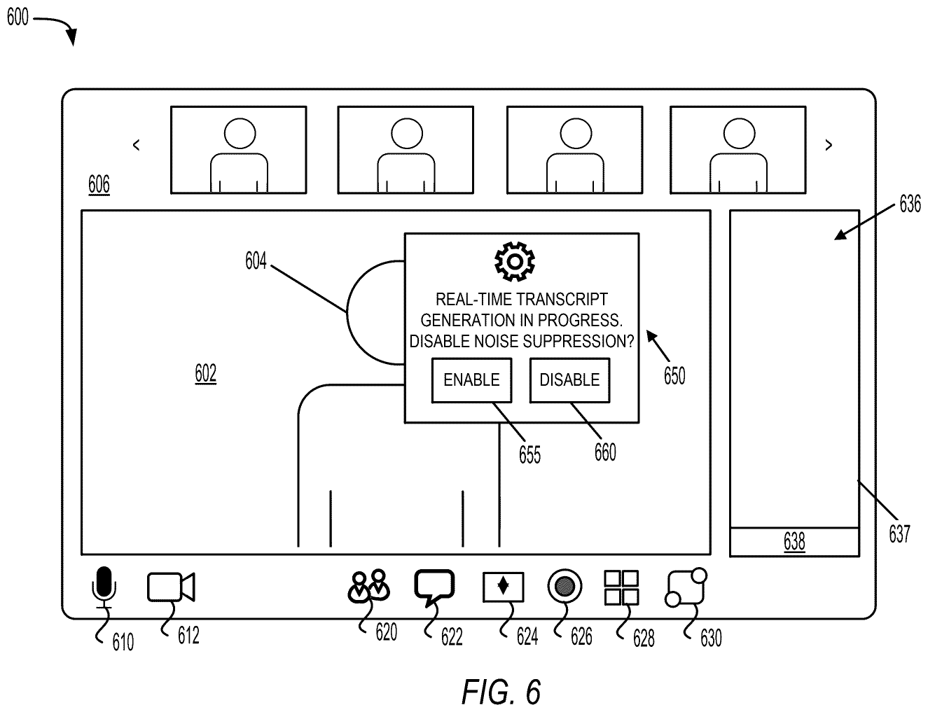

Turning next to FIG. 6, FIG. 6 shows an example of a UI 600 for generating audio streams from modified audio streams and information about the modifications to the audio streams, according to some examples of the present disclosure. FIG. 6 depicts an example of a UI 600 that may be shown on a display device of a client device 408 during video conferencing or chat messaging, although the techniques of this disclosure may be implemented in a variety of client UI contexts. In particular, UI 600 depicts an example of an in-progress video conference in during which noise suppression is enabled, causing generation of information about the modifications to participant audio streams during the video conference.

UI 600 shows an in-progress video conference as may be provided by suitable video conference client software. UI 600 includes a main speaker window 602. In some examples, the UI 600 is configured to display the video conference participant 604 that is currently speaking (e.g., “speaker view”) on the main speaker window 602, but other configurations are possible. For instance, some examples include a UI control for “pinning” a particular participant who can be shown in main speaker window 602 regardless of who is speaking.

The UI 600 includes a number of video conference participants 606. In the UI 600 configuration depicted, the participants 606 are shown at the top of the UI 600. Depending on the configuration, in various examples, the participants 606 may be arrayed in a grid-like fashion, may not be shown at all, or may be displayed in some other manner. In this example, the participants 606 are shown above the main speaker window 602 as smaller participant windows, which allow the participant to view some of the other participants in the video conference, as well as controls (“<” and “>”) to let the host scroll to view other participants in the video conference.

The UI 600 includes a number of controls for configuring the video conference or interacting with the participants 606. For example, the UI 600 includes controls 610 and 612 allow a participant to toggle on or off audio or video streams captured by a microphone or camera connected to the client device 410. Control 620 allows the participant to view any other participants present in the video conference along with the participant. Control 622 allows the participant to execute an application or client software function to send text or chat messages to other participants, whether to specific participants or to the entire meeting. Control 624 allows the participant to share content from their client device. Control 626 allows the participant toggle recording of the meeting, and control 628 allows the participant to select an option to join a breakout room. Control 630 allows the participant to launch an app within the video conference client software, to, for example, access content to share with other participants in the video conference.

The control 622, when selected, can launch a chat application 636. The chat application includes a main chat window 637 that shows a chat history among the participants or a subset thereof. The chat application also includes a chat input control 638 that can be used to input chat messages, share images or video, choose emojis, start threads, and so on.

During the video conference, video conference client software executing on a client device such as client devices 408, 410 may display a noise suppression dialog window 650. The noise suppression dialog window 650 may be displayed in response to another action, such as enabling or disabling real-time generation of a transcript of the video conference which may use ASR services. In response, the user of UI 600 is presented with UI controls such as an enable button 655 or disable button 660. In some examples, following selection of the disable button 660, the client device can output an indication to disable certain modifications of audio streams, such as by disabling the noise suppression 425 of audio processing subsystem. As a result, an unmodified input audio stream may be received by the ASR services generating the video conference transcript.

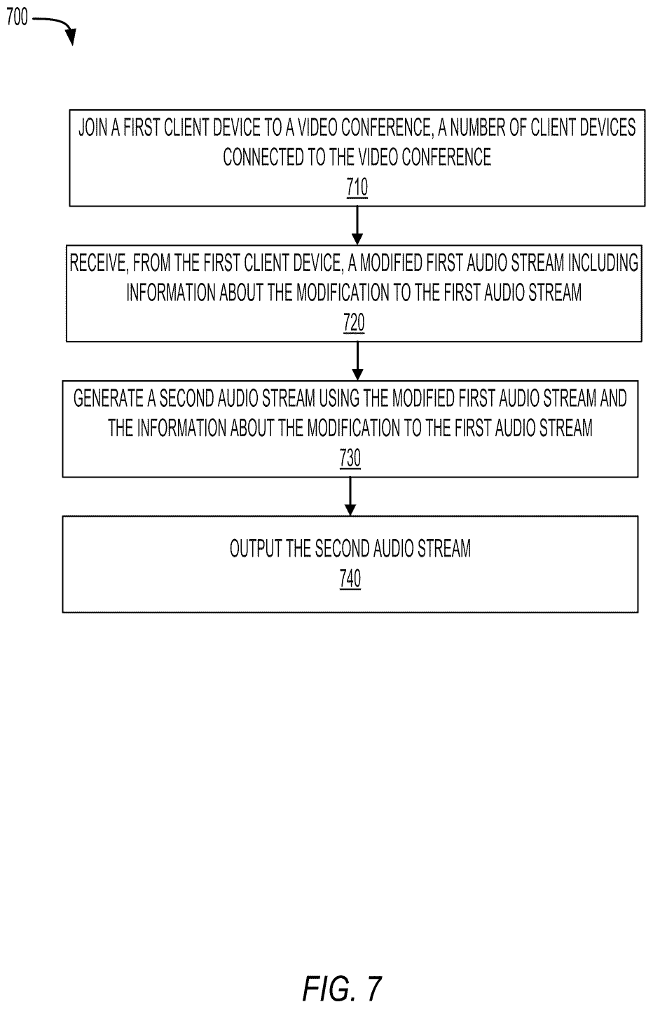

Referring now to FIG. 7, FIG. 7 shows a flowchart of an example method 700 for generating audio streams from modified audio streams and information about the modifications to the audio streams, according to some examples of the present disclosure. The description of the method 700 in FIG. 7 will be made with reference to FIGS. 4-7, however any suitable system according to this disclosure may be used, such as the example systems 100 and 200, shown in FIGS. 1 and 2. It should be appreciated that method 700 provides a particular method for generating audio streams from modified audio streams and information about the modifications to the audio streams. Other sequences of operations may also be performed according to alternative examples. For example, alternative examples of the present disclosure may perform the steps outlined above in a different order. Moreover, the individual operations illustrated by method 700 may include multiple sub-operations that may be performed in various sequences as appropriate to the individual operation. Furthermore, additional operations may be added or removed depending on the particular applications. Further, the operations described in method 700 may be performed by different devices. For example, the description is given from the perspective of the video conference provider 402 but any suitable service provider may be employed. Thus, other configurations are possible. One of ordinary skill in the art would recognize many variations, modifications, and alternatives.

The method 700 may include block 710. At block 710, a computing system, such as video conference provider 402, joins a first client device to a video conference, including a number of client devices connected to the video conference. For example, the first client device can output an indication to the video conference provider 402 including a specification of a video conference to join. The video conference provider 402 can join the first client device to the specified video conference if it is ongoing or instantiate a new video conference, according to the specification. The video conference provider 402 can similarly join the other client devices to the video conference and provide multiplexed receiving and distributing of the various audio and video streams generated by the connected client devices.

At block 720, the computing system receives, from the first client device, a modified first audio stream including information about the modification to the first audio stream. For example, during the video conference, the first client device can receive audio input to an audio input device, such as a participant speaking. The first client device may apply a number of pre-processing algorithms using hardware or software components to this input audio stream to obtain the modified first audio stream such as the components of the audio pre-processing subsystem 415 of FIGS. 4 and 5. For example, the modification to the first audio stream may include noise suppression, acoustic echo cancellation, automatic gain control, or other pre-processing steps.

As the modification is applied, the modifying component can generate the information about the modification to the first audio stream. For instance, as a noise suppression algorithm is applied to the input audio stream, the suppressed noise can be output by the algorithm along with the modified, noise-suppressed first audio stream. The suppressed noise can be included in the information about the modification to the first audio stream.

For example, the information about the modification to the first audio stream may be a representation of the difference between the input audio stream and the modified first audio stream, such that if the difference and the modified first audio stream are combined, the unmodified input audio stream can be recovered. Various digital formats can be used to for the audio streams and the information about the modification. For example, digital lossless formats such as WAV, FLAC, or ALAC may be used for representing audio streams or the difference. In some examples, compressed formats such as OGG, MP3, or AAC may be used.

The information about the modification to the first audio stream may include extension data which can be included in the packets constituting the first audio stream sent over the network. In some examples, the packet may include a header, an audio frame, and the extension data. The extension data may be in any suitable format for transmission and subsequent recombination with the corresponding audio frame.

For instance, the first audio stream may include a number of packets, each packet including audio data in the WAV format representing a portion of the modified (e.g., noise-suppressed) audio. The extension data included in each packet may also include audio data in the WAV format representing a portion of the audio removed during noise suppression for the same period of time as the audio data. In some examples, the formats of the audio frame and the extension data may differ. For example, the audio frame may include data in a lossless format and the extension data may be in a compressed format.

At block 730, the computing system generates a second audio stream using the modified first audio stream and the information about the modification to the first audio stream. For example, the second audio stream may be substantially the same as the unmodified first audio stream. The second audio stream can be generated by combining the audio frame and extension data included in each packet. In some examples in which compressed audio formats are used, an identical unmodified input audio stream may not be recoverable because some information is irrecoverably lost during compression. In these cases, the second audio stream may be nevertheless substantially the same as the unmodified first audio stream and suitable for use in downstream consumers such as ASR components.

At block 740, the computing system outputs the second audio stream. For example, the second audio stream that is substantially the same as the unmodified input audio stream can be output to an ASR service or any other service, such as those discussed above with respect to FIG. 5. The performance of the ASR service may be optimized as a result of using the unmodified input audio stream as input.

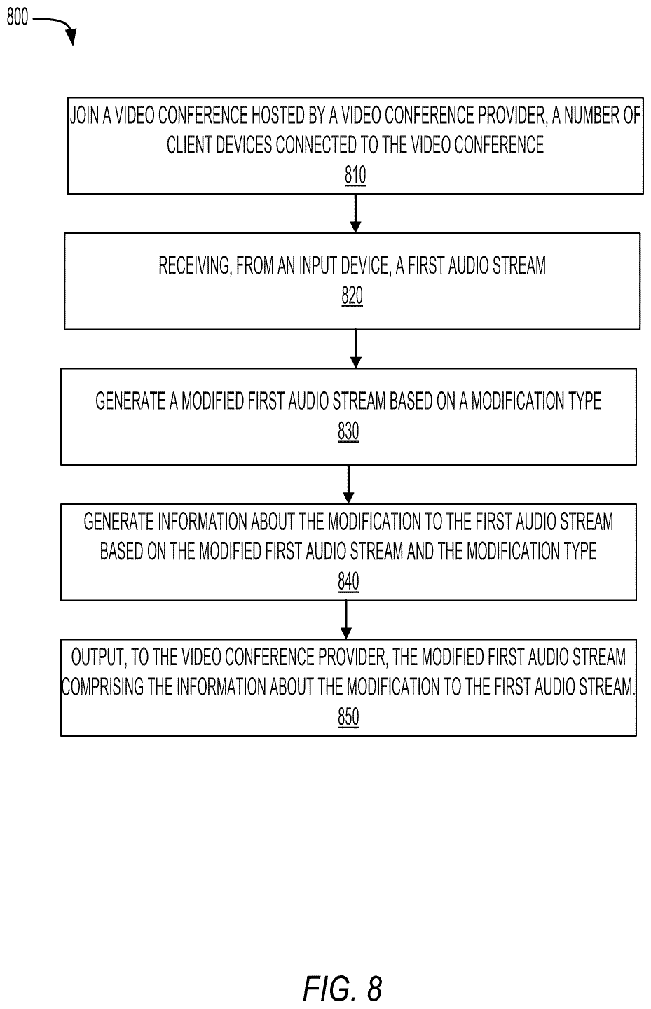

Referring now to FIG. 8, FIG. 8 shows a flowchart of an example method 800 for generating audio streams from modified audio streams and information about the modifications to the audio streams, according to some examples of the present disclosure. The description of the method 800 in FIG. 8 will be made with reference to FIGS. 4-7, however any suitable system according to this disclosure may be used, such as the example systems 100 and 200, shown in FIGS. 1 and 2. It should be appreciated that method 800 provides a particular method for generating audio streams from modified audio streams and information about the modifications to the audio streams. Other sequences of operations may also be performed according to alternative examples. For example, alternative examples of the present disclosure may perform the steps outlined above in a different order. Moreover, the individual operations illustrated by method 800 may include multiple sub-operations that may be performed in various sequences as appropriate to the individual operation. Furthermore, additional operations may be added or removed depending on the particular applications. Further, the operations described in method 800 may be performed by different devices. For example, the description is given from the perspective of a client device, such as client devices 408, 410. but other configurations are possible. In addition, the description is made with respect to a video conference provider 402 but any suitable service provider may be employed. One of ordinary skill in the art would recognize many variations, modifications, and alternatives.

The method 800 may include block 810. At block 810, a client device joins a video conference hosted by a video conference provider, the video conference having a number of connected client devices. For example, the client device can output an indication to the video conference provider 402 including a specification of a video conference to join. The video conference provider 402 can join the first client device to the specified video conference if it is ongoing or instantiate a new video conference, according to the specification. The video conference provider 402 can similarly join the other client devices to the video conference and provide multiplexed receiving and distributing of the various audio and video streams generated by the connected client devices.

At block 820, the client device receives, from an input device, a first audio stream. For example, the client device may have a number of connected audio input devices 412 such as the examples described in FIG. 4. A participant user of the client device may speak into the audio input device during the normal course of video conferencing operations, which may in turn be received by the client device. In some examples, digitization of the received audio input using, for example, an ADC component may be required to generate the first audio stream.

At block 830, the client device generates a modified first audio stream based on a modification type. For example, a component such as the audio pre-processing subsystem 415 may apply hardware or software algorithms to the first audio stream to obtain the benefits of noise suppression, acoustic echo cancellation, automatic gain control, or other pre-processing steps.

At block 840, the client device generates information about the modification to the first audio stream based on the modified first audio stream and the modification type. The modified first audio stream, alone, may not include sufficient information to recover the unmodified first audio stream. Consequently, the difference between the modified first audio stream and the unmodified first audio stream may be separately or ephemerally persisted. The difference may be used to generate the information about the modification to the first audio stream in the form of another audio stream, metadata, text-based or binary difference information, and so on.

At block 850, the client device outputs, to the video conference provider, the modified first audio stream comprising the information about the modification to the first audio stream. For example, the client device may include an audio encoder 435 such as the example described in FIG. 4. The audio encoder 435 can be used to generate a sequence of packets, each of which includes both a portion of the modified first audio stream and the corresponding information about the modification to the portion sufficient to recover the unmodified portion of the first audio stream using a suitable computation technique.

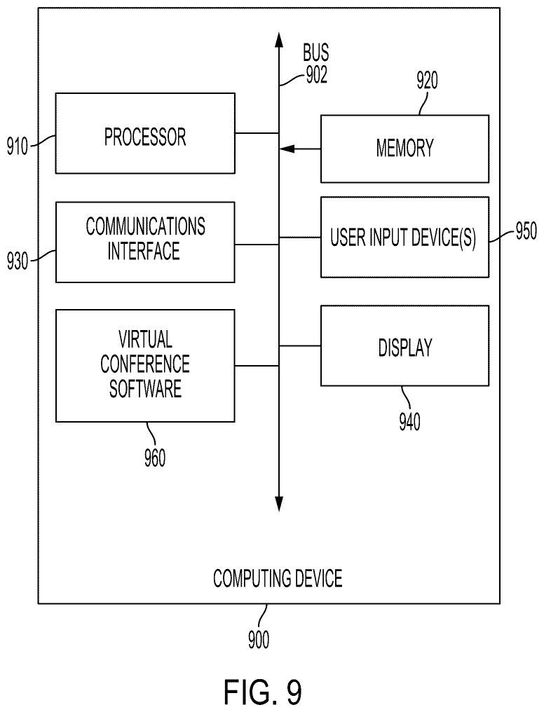

Referring now to FIG. 9, FIG. 9 shows an example computing device 900 suitable for use in example systems or methods for generating audio streams from modified audio streams and information about the modifications to the audio streams, according to some examples of the present disclosure. The example computing device 900 includes a processor 910 which is in communication with the memory 920 and other components of the computing device 900 using one or more communications buses 902. The processor 910 is configured to execute processor-executable instructions stored in the memory 920 to perform one or more methods for generating audio streams from modified audio streams and information about the modifications to the audio streams according to different examples, such as part or all of the example methods 700, 800 described above with respect to FIGS. 7 and 8. The computing device 900, in this example, also includes one or more user input devices 950, such as a keyboard, mouse, touchscreen, microphone, etc., to accept user input. The computing device 900 also includes a display 940 to provide visual output to a user.

In addition, the computing device 900 includes virtual conferencing software 960 to enable a user to join and participate in one or more virtual spaces or in one or more conferences, such as a conventional conference or webinar, by receiving multimedia streams from a virtual conference provider, sending multimedia streams to the virtual conference provider, joining and leaving breakout rooms, creating video conference expos, etc., such as described throughout this disclosure, etc.

The computing device 900 also includes a communications interface 930. In some examples, the communications interface 930 may enable communications using one or more networks, including a local area network (“LAN”); wide area network (“WAN”), such as the Internet; metropolitan area network (“MAN”); point-to-point or peer-to-peer connection; etc. Communication with other devices may be accomplished using any suitable networking protocol. For example, one suitable networking protocol may include the Internet Protocol (“IP”), Transmission Control Protocol (“TCP”), User Datagram Protocol (“UDP”), or combinations thereof, such as TCP/IP or UDP/IP.

While some examples of methods and systems herein are described in terms of software executing on various machines, the methods and systems may also be implemented as specifically-configured hardware, such as field-programmable gate array (FPGA) specifically to execute the various methods according to this disclosure. For example, examples can be implemented in digital electronic circuitry, or in computer hardware, firmware, software, or in a combination thereof. In one example, a device may include a processor or processors. The processor comprises a computer-readable medium, such as a random access memory (RAM) coupled to the processor. The processor executes computer-executable program instructions stored in memory, such as executing one or more computer programs. Such processors may comprise a microprocessor, a digital signal processor (DSP), an application-specific integrated circuit (ASIC), field programmable gate arrays (FPGAs), and state machines. Such processors may further comprise programmable electronic devices such as PLCs, programmable interrupt controllers (PICs), programmable logic devices (PLDs), programmable read-only memories (PROMs), electronically programmable read-only memories (EPROMs or EEPROMs), or other similar devices.

Such processors may comprise, or may be in communication with, media, for example one or more non-transitory computer-readable media, that may store processor-executable instructions that, when executed by the processor, can cause the processor to perform methods according to this disclosure as carried out, or assisted, by a processor. Examples of non-transitory computer-readable medium may include, but are not limited to, an electronic, optical, magnetic, or other storage device capable of providing a processor, such as the processor in a web server, with processor-executable instructions. Other examples of non-transitory computer-readable media include, but are not limited to, a floppy disk, CD-ROM, magnetic disk, memory chip, ROM, RAM, ASIC, configured processor, all optical media, all magnetic tape or other magnetic media, or any other medium from which a computer processor can read. The processor, and the processing, described may be in one or more structures, and may be dispersed through one or more structures. The processor may comprise code to carry out methods (or parts of methods) according to this disclosure.

The foregoing description of some examples has been presented only for the purpose of illustration and description and is not intended to be exhaustive or to limit the disclosure to the precise forms disclosed. Numerous modifications and adaptations thereof will be apparent to those skilled in the art without departing from the spirit and scope of the disclosure.

Reference herein to an example or implementation means that a particular feature, structure, operation, or other characteristic described in connection with the example may be included in at least one implementation of the disclosure. The disclosure is not restricted to the particular examples or implementations described as such. The appearance of the phrases “in one example,” “in an example,” “in one implementation,” or “in an implementation,” or variations of the same in various places in the specification does not necessarily refer to the same example or implementation. Any particular feature, structure, operation, or other characteristic described in this specification in relation to one example or implementation may be combined with other features, structures, operations, or other characteristics described in respect of any other example or implementation.

Use herein of the word “or” is intended to cover inclusive and exclusive OR conditions. In other words, A or B or C includes any or all of the following alternative combinations as appropriate for a particular usage: A alone; B alone; C alone; A and B only; A and C only; B and C only; and A and B and C.

### EXAMPLES

These illustrative examples are mentioned not to limit or define the scope of this disclosure, but rather to provide examples to aid understanding thereof. Illustrative examples are discussed above in the Detailed Description, which provides further description. Advantages offered by various examples may be further understood by examining this specification.

As used below, any reference to a series of examples is to be understood as a reference to each of those examples disjunctively (e.g., “Examples 1-4” is to be understood as “Examples 1, 2, 3, or 4”).

Example 1 is a method, comprising: joining a first client device to a video conference, a plurality of client devices connected to the video conference; receiving, from the first client device, a modified first audio stream comprising information about the modification to the first audio stream; generating a second audio stream using the modified first audio stream and the information about the modification to the first audio stream; and outputting the second audio stream.

Example 2 is the method of example(s) 1, wherein the second audio stream is based on an unmodified first audio stream.

Example 3 is the method of example(s) 1, wherein the second audio stream is output to an automatic speech recognition service.

Example 4 is the method of example(s) 1, wherein the modification to the first audio stream includes noise suppression.

Example 5 is the method of example(s) 4, wherein: the information about the modification to the first audio stream includes a representation of a difference between an unmodified first audio stream and the modified first audio stream; and generating the second audio stream using the modified first audio stream and the information about the modification to the first audio stream comprises combining the representation of the difference with the modified first audio stream.

Example 6 is the method of example(s) 1 further comprising: outputting an indication to disable modification of audio streams; and receiving, from the first client device, an unmodified third audio stream.

Example 7 is the method of example(s) 1, wherein: the information about the modification to the first audio stream comprises extension data, including a representation of the modification to the first audio stream; and the modified first audio stream comprises one or more packets, each packet comprising: a header; an audio frame; and the extension data.

Example 8 is the method of example(s) 7, wherein the representation of the modification to the first audio stream is a third audio stream.

Example 9 is a non-transitory computer-readable medium storing instructions that, when executed by one or more processors, cause the one or more processors to perform operations including: joining a first client device to a video conference, a plurality of client devices connected to the video conference; receiving, from the first client device, a modified first audio stream comprising information about the modification to the first audio stream; generating a second audio stream using the modified first audio stream and the information about the modification to the first audio stream; and outputting the second audio stream.

Example 10 is the non-transitory computer-readable medium of example(s) 9, wherein the modification to the first audio stream includes noise suppression.

Example 11 is the method of example(s) 10, wherein: the information about the modification to the first audio stream includes a representation of a difference between an unmodified first audio stream and the modified first audio stream; and generating the second audio stream using the modified first audio stream and the information about the modification to the first audio stream comprises combining the representation of the difference with the modified first audio stream.

Example 12 is the non-transitory computer-readable medium of example(s) 9 further comprising: outputting an indication to disable modification of audio streams; and receiving, from the first client device, an unmodified third audio stream.

Example 13 is the non-transitory computer-readable medium of example(s) 9, wherein: the information about the modification to the first audio stream comprises extension data, including a representation of the modification to the first audio stream; and the modified first audio stream comprises one or more packets, each packet comprising: a header; an audio frame; and the extension data.

Example 14 is the method of example(s) 13, wherein the representation of the modification to the first audio stream is a third audio stream.

Example 15 is a system comprising: one or more processors; and one or more computer-readable storage media storing instructions which, when executed by the one or more processors, cause the one or more processors to perform operations including: joining a first client device to a video conference, a plurality of client devices connected to the video conference; receiving, from the first client device, a modified first audio stream comprising information about the modification to the first audio stream; generating a second audio stream using the modified first audio stream and the information about the modification to the first audio stream; and outputting the second audio stream.

Example 16 is the system of example(s) 15, wherein the modification to the first audio stream includes noise suppression.

Example 17 is the method of example(s) 16, wherein: the information about the modification to the first audio stream includes a representation of a difference between an unmodified first audio stream and the modified first audio stream; and generating the second audio stream using the modified first audio stream and the information about the modification to the first audio stream comprises combining the representation of the difference with the modified first audio stream.

Example 18 is the system of example(s) 15 further comprising: outputting an indication to disable modification of audio streams; and receiving, from the first client device, an unmodified third audio stream.

Example 19 is the system of example(s) 15, wherein: the information about the modification to the first audio stream comprises extension data, including a representation of the modification to the first audio stream; and the modified first audio stream comprises one or more packets, each packet comprising: a header; an audio frame; and the extension data.

Example 20 is the method of example(s) 19, wherein the representation of the modification to the first audio stream is a third audio stream.

That which is claimed is:

1. A method, comprising:
joining a first client device to a video conference, a plurality of client devices connected to the video conference;
receiving, from the first client device, a modified first audio stream comprising information about the modification to the first audio stream;
generating a second audio stream using the modified first audio stream and the information about the modification to the first audio stream; and
outputting the second audio stream.

2. The method of claim 1, wherein the second audio stream is generated to approximate an unmodified first audio stream.

3. The method of claim 1, wherein the second audio stream is output to an automatic speech recognition service.

4. The method of claim 1, wherein the modification to the first audio stream includes noise suppression.

5. The method of claim 4, wherein:
the information about the modification to the first audio stream includes a representation of a difference between an unmodified first audio stream and the modified first audio stream; and
generating the second audio stream using the modified first audio stream and the information about the modification to the first audio stream comprises combining the representation of the difference with the modified first audio stream.

6. The method of claim 1 further comprising:
outputting an indication to disable modification of audio streams; and
receiving, from the first client device, an unmodified third audio stream.

7. The method of claim 1, wherein:
the information about the modification to the first audio stream comprises extension data, including a representation of the modification to the first audio stream; and
the modified first audio stream comprises one or more packets, each packet comprising:
a header;
an audio frame; and
the extension data.

8. The method of claim 7, wherein the representation of the modification to the first audio stream is a third audio stream.

9. A non-transitory computer-readable medium storing instructions that, when executed by one or more processors, cause the one or more processors to perform operations including:
joining a first client device to a video conference, a plurality of client devices connected to the video conference;
receiving, from the first client device, a modified first audio stream comprising information about the modification to the first audio stream;
generating a second audio stream using the modified first audio stream and the information about the modification to the first audio stream; and
outputting the second audio stream.

10. The non-transitory computer-readable medium of claim 9, wherein the modification to the first audio stream includes noise suppression.

11. The non-transitory computer-readable medium of claim 10, wherein:
the information about the modification to the first audio stream includes a representation of a difference between an unmodified first audio stream and the modified first audio stream; and
generating the second audio stream using the modified first audio stream and the information about the modification to the first audio stream comprises combining the representation of the difference with the modified first audio stream.

12. The non-transitory computer-readable medium of claim 9 further comprising:
outputting an indication to disable modification of audio streams; and
receiving, from the first client device, an unmodified third audio stream.

13. The non-transitory computer-readable medium of claim 9, wherein:
the information about the modification to the first audio stream comprises extension data, including a representation of the modification to the first audio stream; and
the modified first audio stream comprises one or more packets, each packet comprising:
a header;
an audio frame; and
the extension data.

14. The non-transitory computer-readable medium of claim 13, wherein the representation of the modification to the first audio stream is a third audio stream.

15. A system comprising:
one or more processors; and
one or more computer-readable storage media storing instructions which, when executed by the one or more processors, cause the one or more processors to perform operations including:
joining a first client device to a video conference, a plurality of client devices connected to the video conference;
receiving, from the first client device, a modified first audio stream comprising information about the modification to the first audio stream;
generating a second audio stream using the modified first audio stream and the information about the modification to the first audio stream; and
outputting the second audio stream.

16. The system of claim 15, wherein the modification to the first audio stream includes noise suppression.

17. The system of claim 16, wherein:
the information about the modification to the first audio stream includes a representation of a difference between an unmodified first audio stream and the modified first audio stream; and
generating the second audio stream using the modified first audio stream and the information about the modification to the first audio stream comprises combining the representation of the difference with the modified first audio stream.

18. The system of claim 15 further comprising:
outputting an indication to disable modification of audio streams; and
receiving, from the first client device, an unmodified third audio stream.

19. The system of claim 15, wherein:
the information about the modification to the first audio stream comprises extension data, including a representation of the modification to the first audio stream; and
the modified first audio stream comprises one or more packets, each packet comprising:
a header;
an audio frame; and
the extension data.

20. The system of claim 19, wherein the representation of the modification to the first audio stream is a third audio stream.
